(19) United States
(12) Patent Application Publication
(10) Pub. No.: US 2011/0137486 A1
(43) Pub. Date: Jun. 9, 2011

(54) FORWARD VEHICLE SENSING SYSTEM

(75) Inventors: Eun Muk Lim, Ansan (KR); Chan Kyu Lee, Yongin (KR); Dae Youn Um, Suwon (KR); Suk Hwan Cho, Hwaseong (KR); Si Hyoung Lee, Seongnam (KR)

(73) Assignees: HYUNDAI MOTOR COMPANY, Seoul (KR); KIA MOTORS CORPORATION, Seoul (KR)

(21) Appl. No.: 12/788,520

(22) Filed: May 27, 2010

(30) Foreign Application Priority Data
Dec. 4, 2009 (KR) 10-2009-0119872

(51) Int. Cl. G06F 7/00

(52) U.S. Cl. 701/1

(57) ABSTRACT

Disclosed herein is a forward vehicle sensing system for a vehicle. The system includes a sensor and a control unit. The sensor monitors conditions of a road ahead of the vehicle. The control unit detects stationary objects placed on edges of the road, calculates an imaginary line from the consecutive stationary objects, and recognize a prior transverse position of a forward vehicle as a current transverse position of the forward vehicle when determining that an absolute value of a transverse position of the forward vehicle detected on the road is greater than an absolute value of a transverse position of the imaginary line. Therefore, the system of the present invention can prevent the forward vehicle from being incorrectly sensed in such a way as to determine the imaginary line from the stationary objects and compare the transverse position of the forward vehicle to that of the imaginary line.

### CROSS-REFERENCE TO RELATED APPLICATIONS

This application claims under 35 U.S.C. §119(a) priority to Korean Application No. 10-2009-0119872, filed on Dec. 4, 2010, the disclosure of which is incorporated herein by reference in its entirety.

### BACKGROUND OF THE INVENTION

1. Technical Field

The present invention relates generally to forward vehicle sensing systems and, more particularly, to a forward vehicle sensing system which can enhance the efficiency with which a forward vehicle is correctly sensed.

2. Background Art

A variety of systems, which are dependent on the development of various technologies for vehicles, have been developed for safe and convenient driving of a vehicle. For example, a longitudinal control system which measures the distance between a vehicle, and a vehicle in front, and controls the first vehicle according to the variation in the distance therebetween has recently been developed.

In the longitudinal control system, a 77 Hz radio radar is mainly used as a sensor for monitoring conditions ahead of the vehicle. Recently, a longitudinal control system using a 24 Hz radio radar to reduce the production cost has been developed.

The 24 Hz radio radar functions the same as the 77 Hz radio radar, but there is low distinguishing performance owing to a limitation in performance of the radar, so that the efficiency with which a forward vehicle is correctly sensed decreases.

For example, as shown in FIG. 1, when consecutive stationary objects 40, such as a soundproof wall and a median strip, are placed on the edges of a road, if a forward vehicle 30 is close to the stationary object 40, a radar 20 may recognize the forward vehicle 30 and the stationary object 40 as a single object. In this case, the recent position 60 of the forward vehicle is changed into an incorrect value, and as a result the efficiency with which the forward vehicle is correctly sensed is decreased.

Accordingly, there remains a need in the art for new forward vehicle sensing systems.

The above information disclosed in this the Background section is only for enhancement of understanding of the background of the invention and therefore it may contain information that does not form the prior art that is already known in this country to a person of ordinary skill in the art.

### SUMMARY OF THE INVENTION

The present invention features, in preferred aspects, a forward vehicle sensing system. The forward vehicle sensing system of the present invention can preferably prevent a decrease in the efficiency with which a forward vehicle is correctly sensed, wherein the decrease is attributable to consecutive stationary objects.

In preferred embodiments, the present invention provides a forward vehicle sensing system for a vehicle, preferably including a sensor and a control unit. Preferably, the sensor monitors a road ahead of the vehicle. In preferred embodiments, the control unit suitably determines consecutive stationary objects placed on edges of the road, calculates an imaginary line from the consecutive stationary objects, and suitably recognizes a prior transverse position of a forward vehicle as a current transverse position of the forward vehicle when an absolute value of a transverse position of the forward vehicle detected on the road is greater than or equal to an absolute value of a transverse position of the imaginary line.

In further exemplary embodiments of the present invention, the imaginary line may be calculated in such a way as to determine the stationary objects from targets detected by the sensor, set the stationary objects into stationary object groups, arrange the set stationary object groups by relative distance values, and interpolate coordinates of the arranged stationary object groups using a first linear interpolation.

According to further preferred embodiments of the present invention, a mean value of transverse positions of the set stationary object groups may be suitably calculated, and of the set stationary object groups, a stationary object group in which an absolute value of a difference between a transverse position thereof and the mean value is greater than a first reference value may be deleted.

Preferably, each of the detected targets may be determined as a stationary object when a difference between an absolute value of a relative vehicle velocity and an absolute value of an absolute vehicle velocity is less than a second reference value.

In further preferred embodiments, the stationary objects may be set into the stationary object groups according to conditions in which an absolute value of a difference between relative distances of stationary objects is less than a third reference value and an absolute value of a difference between transverse positions of the stationary objects is less than a fourth reference value.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing the principle of a conventional forward vehicle sensing system;

FIG. 2 is a block diagram illustrating a forward vehicle sensing system, according to an embodiment of the present invention;

FIG. 3 is a flowchart of the operation of the forward vehicle sensing system according to the present invention;

FIG. 4 is a view showing details of the operation of the forward vehicle sensing system according to the present invention;

FIG. 5 is a flowchart of the operation of setting an imaginary line in the forward vehicle sensing system according to the present invention; and

FIGS. 6 through 8 are views showing details of the operation of setting the imaginary line in the forward vehicle sensing system according to the present invention.

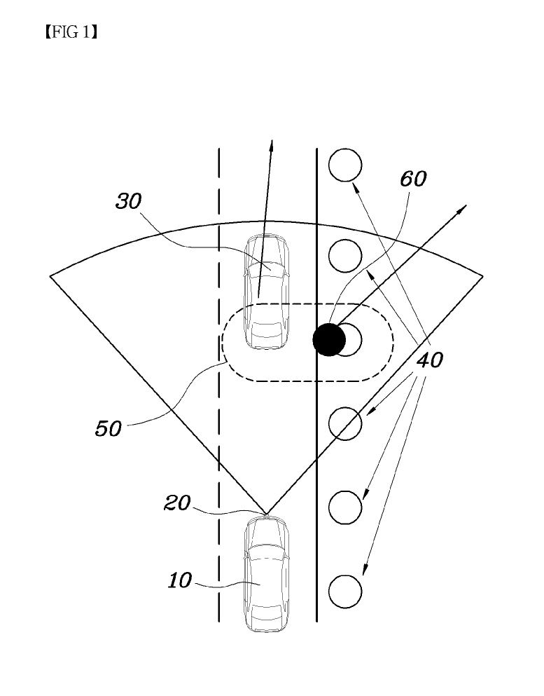

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

In a first aspect, the present invention features a forward vehicle sensing system for a vehicle, comprising a sensor monitoring a road ahead of the vehicle and a control unit determining consecutive stationary objects placed on edges of the road.

In one embodiment, the control unit further calculates an imaginary line from the consecutive stationary objects, and recognizes a prior transverse position of a forward vehicle as a current transverse position of the forward vehicle when an absolute value of a transverse position of the forward vehicle detected on the road is greater than or equal to an absolute value of a transverse position of the imaginary line.

Hereinafter, a preferred embodiment of the present invention will be described in detail with reference to the attached drawings. Reference now should be made to the drawings, in which the same reference numerals are used throughout the different drawings to designate the same or similar components.

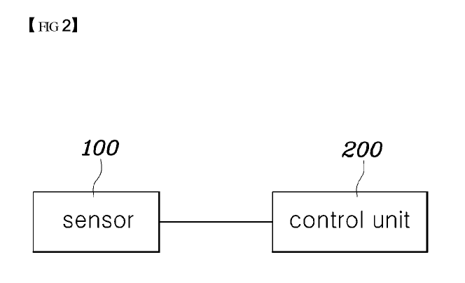

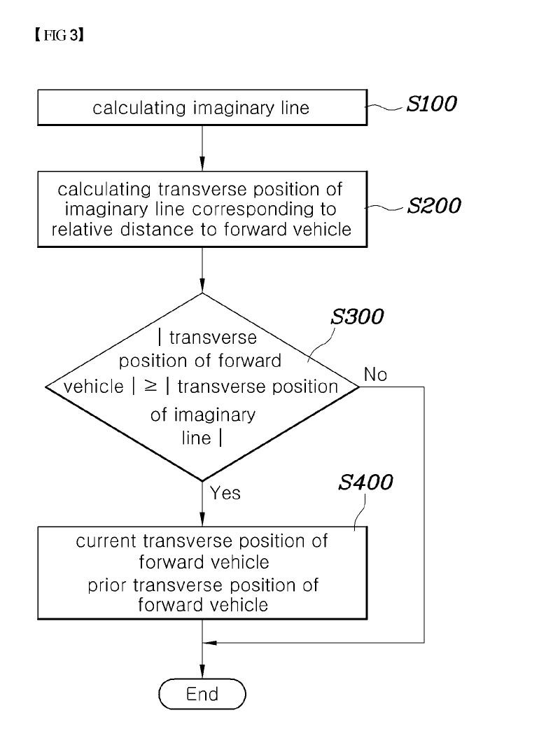

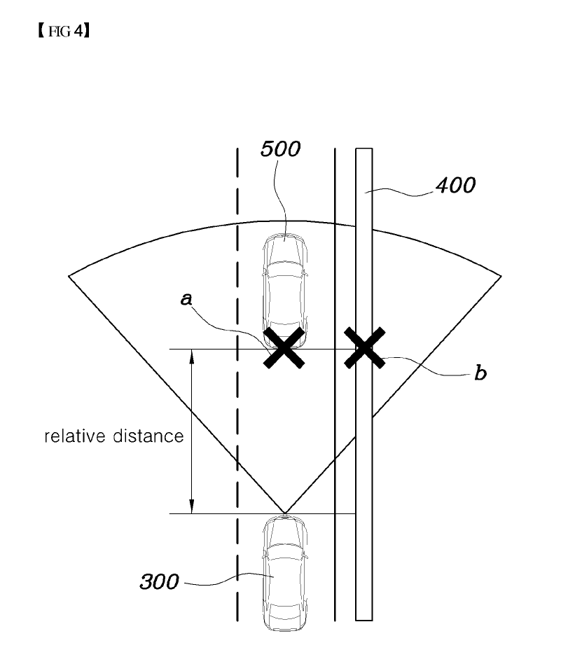

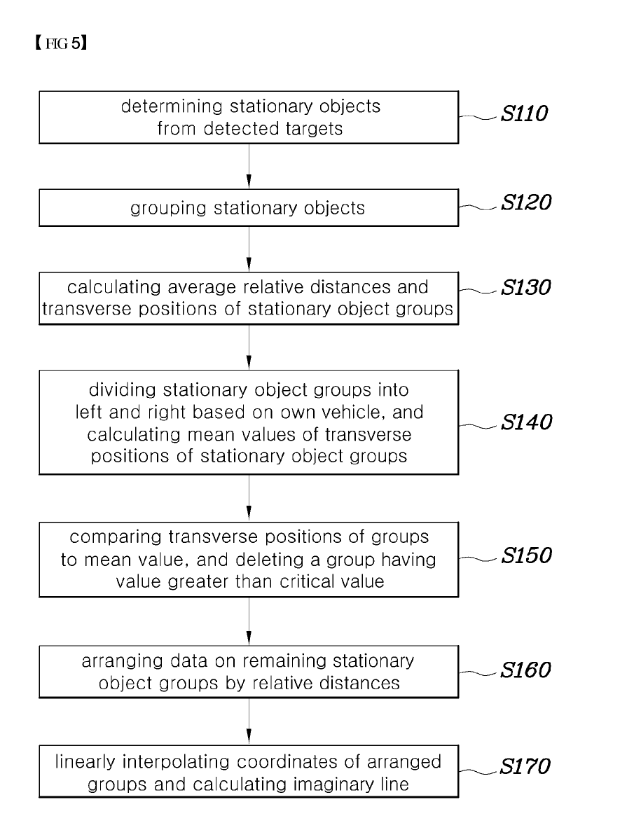

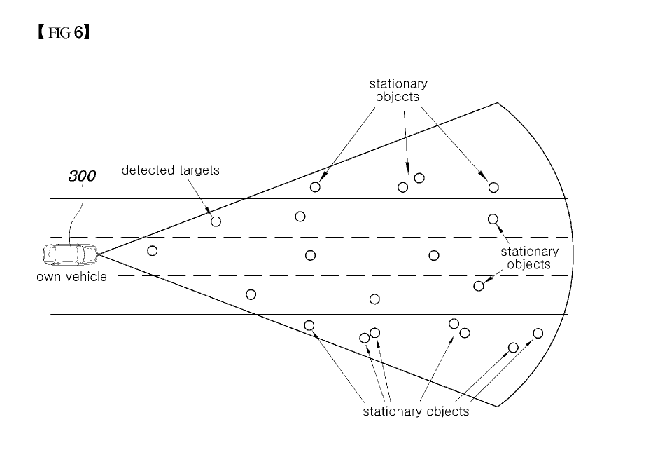

FIG. 2 is a block diagram illustrating a forward vehicle sensing system according to an exemplary embodiment of the present invention. FIG. 3 is a flowchart of the operation of the forward vehicle sensing system according to preferred embodiments of the present invention. FIG. 4 is a view showing details of the operation of the forward vehicle sensing system according to preferred embodiments of the present invention. FIG. 5 is a flowchart of the operation of setting an imaginary line in the forward vehicle sensing system according to the present invention as described herein. FIGS. 6 through 8 are views showing details of the operation of setting the imaginary line in the forward vehicle sensing system according to preferred embodiments of the present invention.

According to certain preferred embodiments, and referring to FIG. 2, for example, the forward vehicle sensing system according to the present invention includes a sensor 100 and a control unit 200. Preferably, the sensor 100 monitors conditions of the road in front of the vehicle. Preferably, the control unit 200 determines the correct position of a forward vehicle in such a way as to sense consecutive stationary objects disposed on the edges of the road, set an imaginary line, and compare the set imaginary line with the position of the forward vehicle.

According to preferred embodiments of the present invention, the sensor 100 functions to monitor conditions of the road ahead of the vehicle. In further preferred embodiments, the sensor 100 monitors a forward vehicle and stationary objects, for example, a guardrail, a soundproof wall, a median strip, etc., which are on the road ahead of the vehicle. In further exemplary embodiments, to achieve this purpose, the sensor 100 may be suitably provided on a rearview mirror to easily monitor conditions ahead of the vehicle. Preferably, a typical 24 GHz radio radar can be used as the sensor 100. According to further preferred embodiments, the location of the sensor 100 is not limited to this. Accordingly, the sensor 100 can be disposed at any position of the vehicle, so long as it can monitor conditions of the road ahead of the vehicle.

According to further preferred embodiments of the present invention, when the sensor 100 senses a forward vehicle and stationary objects, the control unit 200 sets an imaginary line calculated from consecutive stationary objects to prevent the forward vehicle from being incorrectly sensed by the consecutive stationary objects. Accordingly, the control unit 200 compares with the position of the forward vehicle with the imaginary line, thus suitably determining the correct position of the forward vehicle.

According to further exemplary embodiments of the present invention, as shown in FIGS. 3 and 4, at step S100, an imaginary line 400 is suitably calculated from consecutive stationary objects. Further, at step S200, the control unit 200 suitably calculates a transverse position b of the imaginary line 400 corresponding to a relative distance between the vehicle and the forward vehicle. The calculation of the imaginary line 400 will be explained in detail herein, with reference to the corresponding drawing.

According to further exemplary embodiments of the present invention, at step S300, the control unit 200 compares a transverse position a of the forward vehicle 500 with the transverse position b of the imaginary line 400 and determines whether a problem of low distinguishing performance occurs in such a way as to suitably determine whether the forward vehicle 500 invades the imaginary line 400 or the forward vehicle 500 approaches the imaginary line 400 such that a distance therebetween is less than a predetermined value. According to further preferred exemplary embodiments, whether the problem of low distinguishing performance occurs or not can be determined by the following formula 1.

|transverse position of forward vehicle|≧|transverse position of imaginary line| [Formula 1]

Further, when it is suitably determined that the problem of low distinguishing performance occurs, the control unit 200 neglects a transverse position of the forward vehicle 500 which is the current subject of control, and recognizes a transverse position a of the forward vehicle 500 which has been backed up recently as the current transverse position a of the forward vehicle 500. In other exemplary embodiments, when it is suitably determined that the problem of low distinguishing performance does not occur, the control unit 200 suitably maintains the current transverse position a of the forward vehicle 500.

IN other further exemplary embodiments, for example, as shown in FIG. 5, the step of setting the imaginary line 400 preferably includes step S110 of determining stationary objects of targets detected by the sensor. Preferably, as shown in FIG. 6, the stationary objects can be determined in the manner illustrated in FIG. 6. Preferably, whether detected objects are stationary objects can be determined by the following formula 2. Here, a critical value is determined by a value preset as a second reference value.

|relative vehicle velocity|−|absolute vehicle velocity|<critical value [Formula 2]

According to further embodiments of the present invention, after the stationary objects are determined by the sensor 100, the determined stationary objects are suitably grouped, at step S120. Preferably, the grouping of the stationary objects can be suitably determined by the following formula 3. Here, critical values are determined by values preset as a third reference value and a fourth reference value.

(|relative distance 1−relative distance 2|<critical value) and (|transverse position 1−transverse position 2|<critical value) [Formula 3]

Accordingly, at step S130, average relative distances and average transverse positions are suitably calculated by group. According to further preferred embodiments, at step S140, the groups of stationary objects are suitably divided into the left and the right based on the vehicle itself, and the mean values of the transverse positions of the groups of stationary objects are calculated.

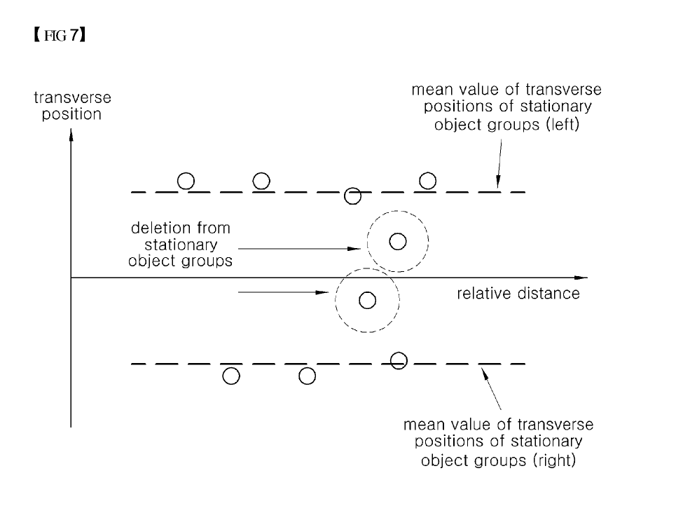

In further preferred embodiments, at step 150, the average transverse positions by group are suitably compared to the corresponding mean value, and a group in which an absolute value of a difference between the average transverse position thereof and the corresponding mean value is greater than a critical value, for example, a first reference value, is deleted, as shown in FIG. 7. Here, a condition of deletion of a stationary object group is determined by the following formula 4.

|transverse position of stationary object group−mean value|>critical value [Formula 4]

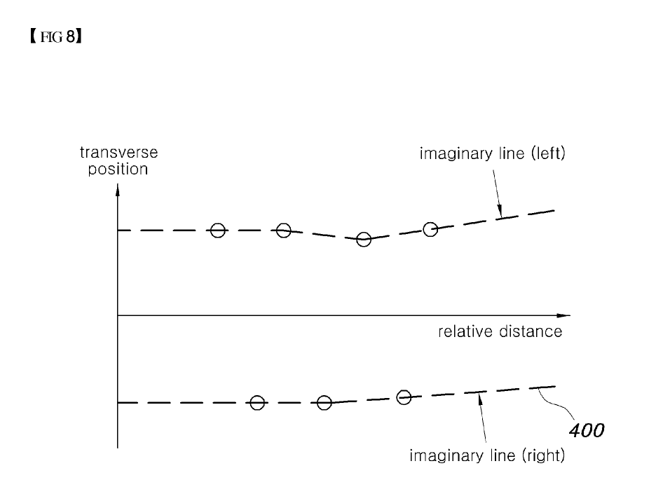

Accordingly, after unnecessary stationary object groups are deleted, for example as shown in FIG. 8, data on the remaining stationary object groups are arranged by relative distances, at step S160. At step S170, coordinates of the arranged groups are linearly interpolated, thus calculating imaginary lines. Preferably, in further exemplary embodiments, the first linear interpolation can be determined by the following formula 5, and characters x and y respectively denote longitudinal and transverse coordinates.

y=(y2−y1)×(x−x1)/(x2−x1)+y1 [Formula 5]

As described above, a forward vehicle sensing system according to the present invention senses a forward vehicle in such a way as to calculate an imaginary line from consecutive stationary objects and compare a transverse position of the forward vehicle with that of the calculated imaginary line. Accordingly, in preferred embodiments, the present invention can suitably prevent the forward vehicle from being incorrectly sensed.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A forward vehicle sensing system for a vehicle, comprising:
a sensor monitoring a road ahead of the vehicle; and
a control unit determining consecutive stationary objects placed on edges of the road, calculating an imaginary line from the consecutive stationary objects, and recognizing a prior transverse position of a forward vehicle as a current transverse position of the forward vehicle when an absolute value of a transverse position of the forward vehicle detected on the road is greater than or equal to an absolute value of a transverse position of the imaginary line.

2. The forward vehicle sensing system as set forth in claim 1, wherein the imaginary line is calculated to determine the stationary objects from targets detected by the sensor, set the stationary objects into stationary object groups, arrange the set stationary object groups by relative distance values, and interpolate coordinates of the arranged stationary object groups using a first linear interpolation.

3. The forward vehicle sensing system as set forth in claim 2, wherein a mean value of transverse positions of the set stationary object groups is calculated, and of the set stationary object groups, a stationary object group in which an absolute value of a difference between a transverse position thereof and the mean value is greater than a first reference value is deleted.

4. The forward vehicle sensing system as set forth in claim 2, wherein each of the detected targets is determined as a stationary object when a difference between an absolute value of a relative vehicle velocity and an absolute value of an absolute vehicle velocity is less than a second reference value.

5. The forward vehicle sensing system as set forth in claim 2, wherein the stationary objects are set into the stationary object groups according to conditions in which an absolute value of a difference between relative distances of stationary objects is less than a third reference value and an absolute value of a difference between transverse positions of the stationary objects is less than a fourth reference value.

6. A forward vehicle sensing system for a vehicle, comprising:
a sensor monitoring a road ahead of the vehicle; and
a control unit determining consecutive stationary objects placed on edges of the road.

7. The forward vehicle sensing system for a vehicle of claim 6, wherein the control unit further calculates an imaginary line from the consecutive stationary objects, and recognizes a prior transverse position of a forward vehicle as a current transverse position of the forward vehicle when an absolute value of a transverse position of the forward vehicle detected on the road is greater than or equal to an absolute value of a transverse position of the imaginary line.
